(19) United States
(12) Patent Application Publication
(10) Pub. No.: US 2025/0033565 A1
(43) Pub. Date: Jan. 30, 2025

(54) NAVIGATION AND MONITORING SYSTEM FOR VEHICLES

(71) Applicant: Hugh Lafon Carter, Burlington, NJ (US)

(72) Inventor: Hugh Lafon Carter, Burlington, NJ (US)

(21) Appl. No.: 18/796,346

(22) Filed: Aug. 7, 2024

Related U.S. Application Data
(63) Continuation-in-part of application No. 16/885,349, filed on May 28, 2020, now abandoned.
(60) Provisional application No. 62/866,936, filed on Jun. 26, 2019.

(51) Int. Cl. B60R 1/27; G01S 13/58; G01S 19/52

(52) U.S. Cl. CPC B60R 1/27; G01S 13/58; G01S 19/52

(57) ABSTRACT

The present invention allows for continuous monitoring of the environment of the vehicle before, during, and after use by the occupant(s). This effectively allows the device to function as a driving aid as well as a theft prevention device. Further, the side facing cameras allow for interactions with law enforcement to be adequately recorded and simultaneously uploaded to a remote server for preservation. In some embodiments, live streaming of the images captured by the cameras is permitted thereby allowing the vehicle and its occupants to be viewed in real time. In embodiments, cameras operate, record, and stream in an independent and controllable manner. Thus, one camera can take images, while another video, while another streams. The imaging has four cameras facing in different directions for 360 degree coverage.

### CLAIM OF PRIORITY

The present application is a U.S. Non-Provisional application claiming priority to U.S. patent application Ser. No. 16/885,349 filed May 28, 2020, entitled “NAVIGATION AND MONITORING SYSTEM FOR VEHICLES”, which claimed priority to Provisional Application No. 62/866,936 filed Jun. 26, 2019 entitled “NAVIGATION AND MONITORING SYSTEM FOR VEHICLES”, the disclosure of which is incorporated herein by reference in its entirety.

### FIELD OF THE EMBODIMENTS

The field of the invention and its embodiments relate to systems for monitoring a vehicle and for navigating said vehicle. In particular, the embodiments relate to a device that enables enhanced vehicle monitoring and interactivity as well as serving as an uplink to communicate information associated with said device to a server.

### BACKGROUND OF THE EMBODIMENTS

Video recorders or dash mounted cameras, either stock or aftermarket, are installed on vehicles. These devices can record images of the passengers, the environment of the vehicle, and/or other views relating to the vehicle and its occupants. These same vehicles are often equipped with GPS navigation systems that allow the locations of the vehicles to be tracked. In the event of an accident, law enforcement event, or other incident involving the vehicle or the actions of its occupants, however, there is currently no means for independently correlating the occurrence of events within or outside the vehicle with the specific location of the vehicle at the time of the events.

### REVIEW OF RELATED TECHNOLOGY

U.S. Pat. No. 7,728,721 pertains to an accessory system suitable for use in an interior cabin of a vehicle includes an attachment element adhesively attached to an interior surface of a windshield of a vehicle, and an accessory module. The accessory module includes structure adapted to attach to the attachment element. The accessory module encompasses an antenna and a forward-facing camera. The forward-facing camera has a forward field of view through the windshield of the vehicle and in the direction of forward travel of the vehicle. The accessory system may include an image processor for processing image data captured by the forward-facing camera. The forward-facing camera may capture images for at least one of a collision avoidance system and an automatic headlamp control system.

U.S. Patent Application 2008/0309762 pertains to a mobile digital video surveillance recorder with GPS mapping capability is provided that is carried by a vehicle and equipped with a plurality of channel inputs. An associated monitor can be carried by the vehicle to allow the driver to view the camera images being recorded real-time, or the monitor can be located remotely for playback and review of the recorded images later. The monitor displays a split screen that can display one or more images as taken from different cameras. Video feed from an associated GPS navigation system is piped into one of the video channel inputs such that GPS location with mapping is visually displayed as one of the remaining split-screen images on the monitor. The displayed data therefore presents concurrent images of camera video and GPS video feed so that the specific location of the vehicle at the time a camera image was recorded is presented.

U.S. Patent Application 2004/0145457 pertains to a vehicular video mirror system includes an interior rearview mirror assembly and a video display assembly. The interior rearview mirror assembly includes a mirror casing incorporating a reflective element. The reflective element has a rearward field of view when the interior rearview mirror assembly is mounted in a vehicle. The mirror assembly further includes a mirror-mounting portion, which is adapted to mount the interior rearview mirror assembly at an interior portion of the vehicle, such as a windshield portion or a header portion. The mirror casing is adjustable about the mirror-mounting portion for adjusting the rearward field of view of the reflective element. The video display assembly includes a video screen which is incorporated in a video display housing. The video display assembly also includes a display-mounting portion, which is adapted to mount the video display assembly at the interior portion of the vehicle. The display housing is adapted to be adjustable about the display-mounting portion for adjusting the orientation of the video screen and, further, for moving the display housing to a stowed position whereby the video screen is generally not viewable by a driver when seated in a vehicle seat in the vehicle to thereby minimize the distraction to the driver of the vehicle.

Various devices are known in the art. However, their structure and means of operation are substantially different from the present disclosure. The other inventions also fail to solve all the problems taught by the present disclosure. At least one embodiment of this invention is presented in the drawings below and will be described in more detail herein.

### SUMMARY OF THE EMBODIMENTS

In general, the present invention and its embodiments provide for an image capturing device having built in navigational functionality. In some embodiments, a radar detector is further encompassed. The image capturing capability is configured to provide 360-degree views of an environment of the location of the device. In at least one embodiment, the device contains a transceiver configured to transmit and receive data from a server coupled to the device.

The embodiments of the present invention allow for continuous monitoring of the environment of the vehicle before, during, and after use by the occupant(s). This effectively allows the device to function as a driving aid as well as a theft prevention device. Further, the side facing cameras allow for interactions with law enforcement to be adequately recorded and simultaneously uploaded to a remote server for preservation. In some embodiments, live streaming of the images captured by the cameras is permitted thereby allowing the vehicle and its occupants to be viewed in real time.

In one embodiment of the present invention there is a device for monitoring a vehicle environment, the device comprising a first image capturing device, a second image capturing device, a third image capturing device, and a fourth image capturing device, wherein an orientation of each of the first image capturing device, the second image capturing device, the third image capturing device, and the fourth image capturing device are different from one another; a processor and memory configured to store a representation captured by any of the first image capturing device, the second image capturing device, the third image capturing device, and the fourth image capturing device; a touch based display; a global positioning system sensor; at least one of: a laser light sensor and a radio frequency sensor; and a mounting apparatus.

In yet another embodiment of the present invention there is a device for monitoring a vehicle environment, the device comprising: a first camera, a second camera, a third camera, and a fourth camera, wherein an orientation of each of the first camera, the second camera, the third camera, and the fourth camera, are different from one another, and wherein an orientation of the first camera and the third camera an in opposing directions from one another, and wherein an orientation of the second camera and the fourth camera and in opposing directions from one another; a touch-based display configured to display a representation of a location of a vehicle;

a sensor configured to receive light signals and/or radio frequency signals; and a processor and a memory configured to: record images captured by the first camera, the second camera, the third camera, and the fourth camera, and create alerts visible to the user via the touch-based display; a transceiver configured to send data collected by the device to a server.

One embodiment is directed to a device for monitoring a vehicle environment, which includes: a housing, which is approximately rectangular having six faces; a first image capturing device; a second image capturing device; a third image capturing device; a fourth image capturing device, each of the image capturing devices being substantially at a ninety degree angle from each other, which results in three hundred and sixty degree coverage, wherein each is positioned on one face of the housing excluding a top face and a bottom face; a digital image sensor having a singular surface that receives light from each of the image capturing devices; a processor configured to perform digital signal processing tasks on output from the digital image sensor to produce a set of digital media files, which include image files and video files, wherein image files are stored in a standardized image format viewable via a conventional media player, wherein video files are stored in a standardized video format viewable via a conventional media player; and a data store that stores the digital media files, wherein the device permits a user to independently control and determine how output from each of the image capturing devices is processed, wherein said independent control permits a video file to be created that includes video from a first subset of one to three of the image capturing devices while concurrently permitting creation of a set of at least one image files from a user selected second subset of one to three of the image capturing devices, wherein none of the image capturing devices of the first subset are in the second subset.

Further, each of the image capture devices can direct captured optical imagery on different, substantially non-overlapping regions of the digital image sensor. The processor can include at least four cores, where specific cores are dedicated to digital signal processing of specific ones of the image capturing devices. Each of the image capturing devices can include a lens that optically channels light to ultimately strike a surface of the digital image sensor.

One embodiment is directed to a device for monitoring a vehicle environment of a vehicle, the device includes: a housing, which is approximately rectangular having six faces; a first image capturing device; a second image capturing device; a third image capturing device; a fourth image capturing device, each of the image capturing devices being substantially at a ninety degree angle from each other, which results in three hundred and sixty degree coverage, wherein each is positioned on one face of the housing excluding a top face and a bottom face; a digital image sensor having a singular surface that receives light from each of the image capturing devices; a processor configured to preform digital signal processing tasks on output from the digital image sensor to produce a set of digital media files; a data store that stores the digital media files; and a speed detector component, which is at least one of a radar detector and a LIDAR detector, wherein the device is configured to responsive to the speed detection component sensing occurrence of a speed detection activity targeting the vehicle, the image capturing devices are automatically activated to begin continuously capturing images in the three hundred and sixty degree coverage, wherein said captured images are stored in the data store within at least one of the media files.

One embodiment is directed to a device for monitoring a vehicle environment of a vehicle, the device including a housing, which is approximately rectangular having six faces; a first image capturing device; a second image capturing device; a third image capturing device; a fourth image capturing device, each of the image capturing devices being substantially at a ninety degree angle from each other, which results in three hundred and sixty degree coverage, wherein each is positioned on one face of the housing excluding a top face and a bottom face; a digital image sensor having a singular surface that receives light from each of the image capturing devices; a processor configured to preform digital signal processing tasks on output from the digital image sensor to produce a set of digital media files; a data store that stores the digital media files; and a mounting apparatus, wherein the mounting apparatus permits free rotation of the device while being used.

In general, the present invention succeeds in conferring the following, and others not mentioned, benefits and objectives.

It is an object of the present invention to provide a device that monitors an internal and/or external environment of a vehicle.

It is an object of the present invention to provide a device that detects radar signals from a third party.

It is an object of the present invention to provide a device that contains a navigation function.

It is an object of the present invention to provide a device that allows for images and/or video to be live streamed.

It is an object of the present invention to provide a device that has touch screen capabilities.

It is an object of the present invention to provide a device can auto swivel to remain oriented in a fixed direction.

It is an object of the present invention to provide a device that allows for anti-theft vehicle monitoring.

It is an object of the present invention to provide a device that is easy to set up and use.

### BRIEF DESCRIPTION OF THE DRAWINGS

FIG. 1A is a system figure for the navigation device in accordance with embodiments of the present invention.

FIG. 1B shows a CMOS image sensor according to a preferred embodiment of the present invention.

FIG. 2A shows a is a first perspective view of an embodiment of the present invention.

FIG. 2B is a second perspective view of an embodiment of the present invention.

FIG. 2C is a first side view of an embodiment of the present invention.

FIG. 2D is a front view of an embodiment of the present invention.

FIG. 2E is a back view of an embodiment of the present invention.

FIG. 3 shows a computing device in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

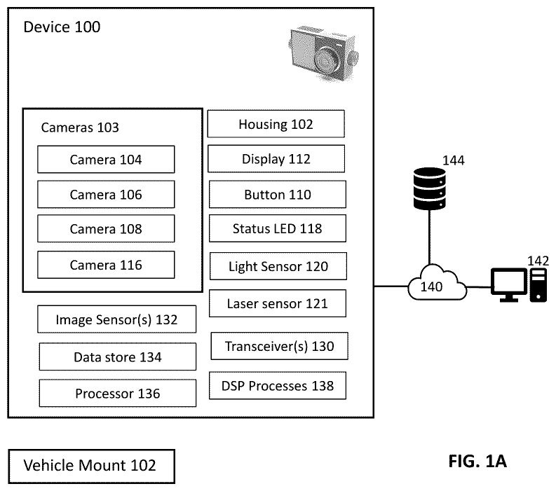

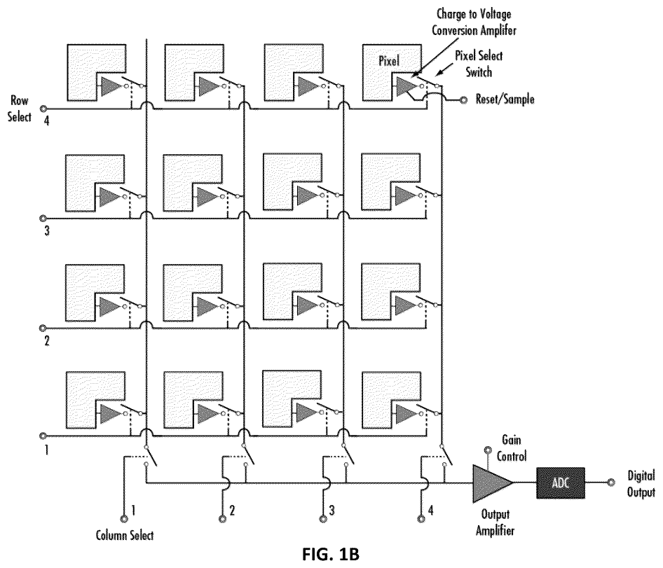

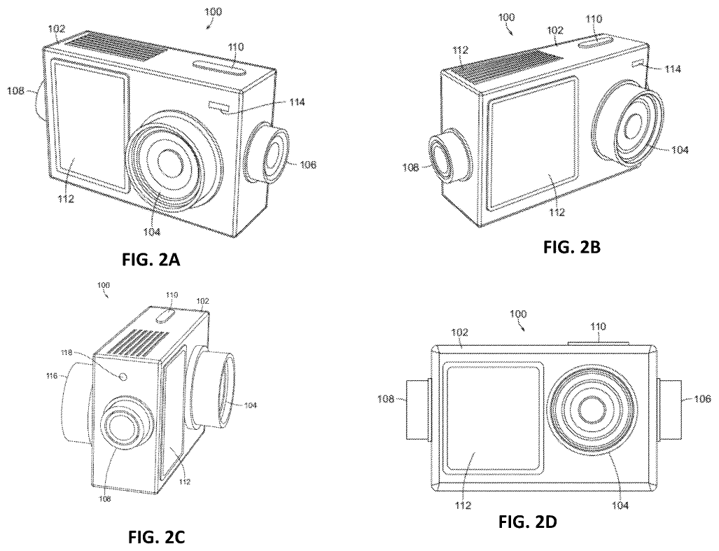

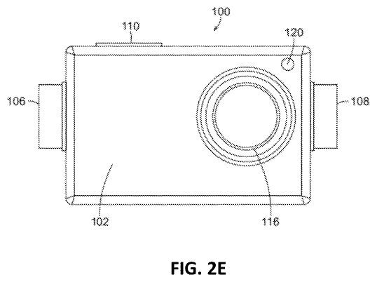

Referring now to FIG. 1A, FIGS. 2A, 2B, 2C, 2D, and 2E, a device 100 can include a set of cameras 103, such as a first camera 104, a second camera 106, a third camera 108, and a fourth camera 116. These cameras can each be located on a face of a six sided housing 102, excluding a top and bottom face. The device 100 also includes a display 112, a button 110, a status LED 118, a light sensor 120, a laser sensor 123, a transceiver 130, a set of digital signal processing (DSP) processes 138, a data store 134, a processor 136, and one or more image sensors 132. A vehicle mount 102 can be coupled to the device 100 in embodiments.

Further, the device 100 may wirelessly communicate over a network 140 to remotely located data store(s) 144 and/or computing devices 142. For example, the device 100 can stream video to a data store 144 or over a social media connection, which permits remote individuals to monitor a vehicle in which device 110 is mounted (102), people inside such a vehicle, and the like. In embodiments, monitoring, recording, etc. can be triggered by a user selected control, such as button 110 or an option selected via a touch screen (112). In embodiments, a condition detected by a sensor (e.g., laser sensor 121, a speed detector, a motion sensor, an accelerometer, a microphone characteristic sound, etc.) can trigger image/video recording and/or streaming. The recording and/or streaming of images/video can keep occupants of a vehicle safe and may be useful to assess culpability in vehicle collisions. Further, vehicle occupants having a fear of police, security, or other stops and a desire to record such incidents are benefited by the device 100.

In some embodiments, a mounting apparatus may be used to secure a position of the device 100 within a vehicle. The mounting apparatus may couple the device 100 to a window of the vehicle. The mounting apparatus may removably couple the device 100 to the vehicle. Typical mechanisms such as suction mechanisms and adhesives may be used to create the pairing between the window and the mounting mechanism. The mounting mechanism further has a receptacle to receive the device 100. The receptacle may comprise arms or other devices to form a friction fit with the device 100. In other embodiments, the mounting device is adapted to engage grooves or other structures of the device 100 in order to secure a position of the device and the mounting mechanism.

In at least one embodiment, the mounting mechanism allows for free rotation of the device 100 when coupled to the mounting mechanism. This may allow for stabilization of the video or images captured by the device 100. Further, this may allow for a particular orientation of the device to be maintained by the device 100 when the vehicle is in motion. In yet other embodiments, the mounting mechanism may have a transceiver configured to receive a signal from an electronic device. This may allow for the mounting apparatus to control a position of the device 100 remotely.

Preferably, the device 100 has a housing 102 that comprises a first side, second side, third side, fourth side, fifth side, and sixth side. In other embodiments, other housing iterations (shapes, sizes, etc.) are envisioned. The device 100 has four cameras: a first camera 104, a second camera 106, a third camera 108, and a fourth camera 116. Each of the cameras are disposed on a separate side of the housing 102. It is preferable that each of the four cameras are oriented or face in a different direction. In at least one embodiment, the cameras are oriented such that each camera is oriented 90 degrees from another camera. Combined with the desired field of view for each of the cameras, this allows for 360 degree camera coverage by the device 100. In at least one embodiment, a first pair of cameras face in opposing directions and a second pair of cameras face in opposing directions. The direction of the first pair of cameras is distinct from the direction of the second pair of cameras.

The cameras may be configured to capture video in 1080p, 4k, or other desirable resolution. The cameras may be configured to capture images having at least 5 megapixels. Each of the cameras may be capable of being independently controlled. For example, one camera can record video while another camera is simultaneously capturing a still image. In some embodiments, a motion sensor is coupled to the camera such that movement detection by the motion sensor causes activation of the camera coupled to the motion sensor.

The device 100 further has a touch-based display 112. Such a touch-based display may be a resistive touch display, a capacitive touch display, or other suitable display. The touch-based display 112 provides a visual output to the user of various data associated with and collected by the device. For example, the user may adjust various settings of the device 100 via the touch-based display 112. Further, the touch-based display may be configured to output a navigational program to guide a driver in reaching a desired destination. The device further incorporates global positioning system capabilities to aid in such functionality.

On a front of the device 100, there is a light/laser sensor 120 configured to receive various forms of light, radio frequency signals, laser light, etc. Typically, this is used to receive incoming transmission from radar guns utilized by law enforcement. Once detected, the device 100 may trigger an audible alarm via a speaker built into the device. In another embodiment, the device 100 may cause an alert to be generated on the touch-based display 112 warning the driver to slow down.

Another feature of the device 100 is that the video or images captured by the device 100 may be live streamed by the device 100. This may be done by interacting with the touch-based display 112 or there may be a dedicated button on the device to allow the streaming action to occur. The images and video may be streamed directly to a dedicated website or to a third-party mobile and/or web application. For example, there may be a dedicated touch sensitive button that allows for the images or video to be streamed directly to FACEBOOK LIVE, other social media site, or other remote location (e.g., storage 144 or computer 142). This may be done solely for entertainment purposes or may be done in the event of a law enforcement event. For example, a user is pulled over by a police officer and wants to obtain and preserve or live stream the interaction for safety purposes. Further, such data may be useful in the event of any court proceeding.

At least one depressible button 110 is present on the device as well as at least one status LED 118. The depressible button 110 is used to interact with various features of the device 100, in particular, to turn on/off various functionality associated with the device 100. The status LED 118 may be used to signify the operation of a particular functionality (i.e. recording on/off) such that a user has a visual cue as to the operation of the intended functionality.

In one embodiment, each camera 103 is an image capturing device or a set of lenses and light pathways that directs light to one or more image sensor(s) 132. The image sensor 132 is a digital one and is preferably a complementary metal oxide semiconductor (CMOS) sensor. In other embodiments, sensor 132 can be a charge-coupled device (CCD), a Short-wave infrared (SWIR), or other digital image sensor. In one embodiment, more than one of the cameras 103 directs light to a single image sensor 132. For example, all four cameras (104, 106, 108, and 116—also referred to as image devices) can direct light to the same sensor 132. Alternatively, two of the cameras 103 can direct light to one sensor 132 and two remaining ones can to another. In another embodiment, each camera 103 can have a dedicated associated image sensor 132.

In one embodiment, different non-overlapping regions of the image sensor 132 can be struck by light from different cameras 104, 106, 108, and 116. Each region being separately processed by processor 136 and/or by DSP processes 138. In one embodiment, different cores of a multi-core processor can be dedicated to different cameras 104, 106, 108, 116. Alternatively, light from the different cameras 104, 106, 108, 116 can be time spaced over a reoccurring cycle (of four) to ensure a time based separation between images from different ones of the lenses. The time spacing is significantly small and processing significantly fast to ensure that real time video is able to be separately captured from each of the different cameras 104, 106, 108, and 116.

Regardless of specific technology employed, device 110 allows each camera 104, 106, 108, and 116 to be independently controlled in real time per user direction. Thus, one camera 104 can take still images as stored 134 image files having an image format (e.g., TIFF, JPEG, PNG, etc.) while a different camera 106 facing a different direction (inherently) captures a video stored 134 as a video file in a video format (e.g., MP4, .vid, .avi, etc.). The formatting and processing requires different operations (138) to occur relatively concurrently, which is why in embodiment using different cores of processor 136 are preferred, where the DSP processes are multithreaded ones dedicated to different cores. In other embodiments, imagery from multiple cameras can be combined in panoramic images/video, which are stored (134) in a single file. Further, streaming of video, sets of images can also occur in embodiments, which requires different formats and DSP processes 138 than those required for stored media files.

In embodiments, the laser sensor 120 or other speed detection device can trigger a beginning of the image/video recording/streaming. That is, once a vehicle in which device 100 is mounted (102) is hit with RADAR or LIDAR, a user is able to have self-record a related event automatically. In one embodiment, GPS information, such as location and speed can be time recorded and time synchronized to the video. While this functionality is generally available, it is particularly valuable for automatic recordings triggered by a speed detection device. For example, device 100 recordings may show a driver was traveling at 25 MPH, where a report written by a traffic cop may profess higher vehicle speeds at the time of a stop. Incorporation of additional information into a video/image stream in a time synchronized fashion ensures a driver is not liable for acts/events that are misinterpreted by others. In another example, 360 video recording can be triggered by a sudden deceleration characteristic of a crash or pre-crash braking. Thus, an accident is automatically recorded and records of the same are retailed (stored in store 134) in files under the owner's control. In other words, privacy for device 100 owner is maintained, and no streaming or communications (over network 140) occur unless authorized by an owner.

In embodiments, however, it is contemplated that a parent could monitor driving of a minor via device 100, or that even driving behavior of a known alcohol addict could be remotely monitored. In a preferred embodiment, no recordings are taken by device 100 or sent elsewhere without full permission/authorization of a driver. In embodiments, encryption techniques can be used on files stored (134) to minimize exposure of unauthorized monitoring. In embodiments, slides (optical blockers) can be manually applied to the different cameras 104, 106, 108, 116 (optical capture regions) to ensure no remote images are possible, for the security conscious.

With reference to FIG. 1B, a complementary metal oxide semiconductor (CMOS) image sensor (132) is shown, which is a preferred image sensor for embodiments. In a CMOS sensor, the charge from the photosensitive pixel is converted to a voltage at the pixel site and the signal is multiplexed by row and column to multiple on chip digital-to-analog converters (DACs). Inherent to its design, CMOS is a digital device. Each site is essentially a photodiode and three transistors, performing the functions of resetting or activating the pixel, amplification and charge conversion, and selection or multiplexing. This leads to the high speed of CMOS sensors, but can result in low sensitivity as well as high fixed-pattern noise due to fabrication inconsistencies in the multiple charge to voltage conversion circuits. Digital signal processing (DSP) operations or processes 138 are conducted to minimize these inconsistencies and noise.

### Systems, Devices and Operating Systems

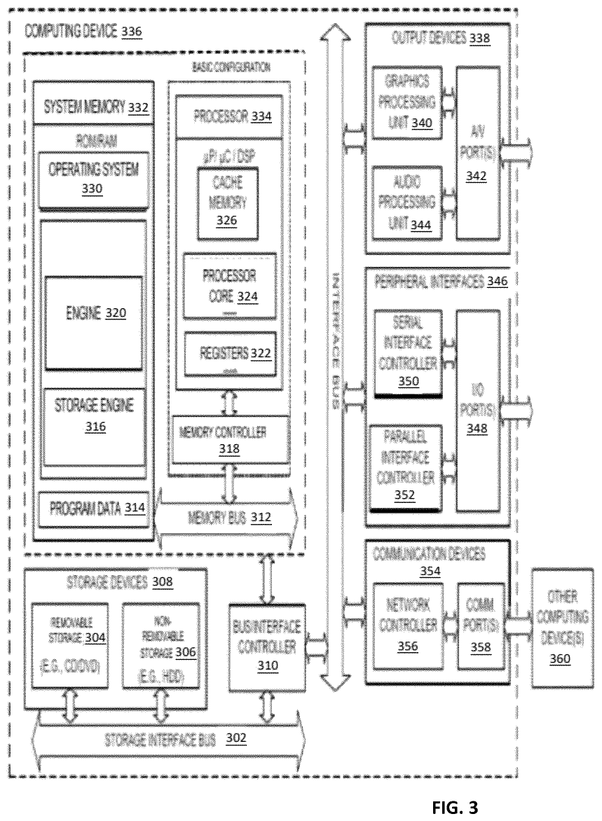

A basic configuration of a computing device is illustrated in FIG. 3 by those components within the inner dashed line. In the basic configuration of the computing device 336, the computing device 336 includes a processor 334 and a system memory 312. The terms “processor” and “central processing unit” or “CPU” are used interchangeably herein. In some examples, the computing device 336 may include one or more processors and the system memory 332. A memory bus 312 is used for communicating between the one or more processors 334 and the system memory 332.

Depending on the desired configuration, the processor 334 may be of any type, including, but not limited to, a microprocessor (μP), a microcontroller (μC), and a digital signal processor (DSP), or any combination thereof. In examples, the microprocessor may be AMD's ATHLON, DURON, and/or OPTERON; ARM's application, embedded and secure processors; IBM and/or MOTOROLA's DRAGONBALL and POWERPC; IBM's and SONY's Cell processor; INTEL'S CELERON, CORE (2) DUO, ITANIUM, PENTIUM, XEON, and/or XSCALE; and/or the like processor(s).

Further, the processor 334 may include one more levels of caching, such as a level cache memory 326, a processor core 324, and registers 322, among other examples. The processor core 324 may include an arithmetic logic unit (ALU), a floating point unit (FPU), and/or a digital signal processing core (DSP Core), or any combination thereof. A memory controller 318 may be used with the processor 334, or, in some implementations, the memory controller 318 may be an internal part of the memory controller 318.

Depending on the desired configuration, the system memory 332 may be of any type, including, but not limited to, volatile memory (such as RAM), and/or non-volatile memory (such as ROM, flash memory, etc.), or any combination thereof. The system memory 332 includes an operating system 330, one or more engines, such as an engine 320, and program data 314. In some embodiments, the engine 320 may be an application, a software program, a service, or a software platform, as described infra. The system memory 332 may also include a storage engine 316 that may store any information of data disclosed herein.

The operating system 330 may be a highly fault tolerant, scalable, and secure system such as: APPLE MACINTOSH OS X (Server); AT&T PLAN 9; BE OS; UNIX and UNIX-like system distributions (such as AT&T's UNIX; BERKLEY SOFTWARE DISTRIBUTION (BSD) variations such as FREEBSD, NETBSD, OPENBSD, and/or the like; Linux distributions such as RED HAT, UBUNTU, and/or the like); and/or the like operating systems. However, more limited, and/or less secure operating systems also may be employed such as APPLE MACINTOSH OS, IBM OS/2, MICROSOFT DOS, MICROSOFT WINDOWS 2000/2003/3.1/95/98/CE/MILLENNIUM/NT/VISTA/XP (Server), PALM OS, and/or the like. The operating system 330 may be one specifically optimized to be run on a mobile computing device (e.g., one configuration for device 118), such as iOS, ANDROID, WINDOWS Phone, TIZEN, SYMBIAN, and/or the like.

As explained supra, the GUI may provide a baseline and means of accessing and displaying information graphically to users. The GUI may include APPLE MACINTOSH Operating System's AQUA, IBM's OS/2, Microsoft's WINDOWS 2000/2003/3.1/95/98/CE/MILLENNIUM/NT/XP/Vista/7 (i.e., AERO), UNIX'S X-Windows (e.g., which may include additional UNIX graphic interface libraries and layers such as K DESKTOP ENVIRONMENT (KDE), MYTHTV and GNU Network Object Model Environment (GNOME)), web interface libraries (e.g., ActiveX, AJAX, (D) HTML, FLASH, JAVA, JAVASCRIPT, etc. interface libraries such as, but not limited to, DOJO, JQUERY (UI), MOOTOOLS, PROTOTYPE, SCRIPT.ACULO.US, SWFOBJECT, or YAHOO! User Interface, any of which may be used.

Additionally, a web browser component (not shown) is a stored program component that is executed by the CPU. The web browser may be a conventional hypertext viewing application such as MICROSOFT INTERNET EXPLORER, EDGE, CHROME, FIREFOX, or NETSCAPE NAVIGATOR. SECURE WEB browsing may be supplied with 128 bit (or greater) encryption by way of HTTPS, SSL, and/or the like. Web browsers allowing for the execution of program components through facilities such as ACTIVEX, AJAX, (D) HTML, FLASH, JAVA, JAVASCRIPT, web browser plug-in APIs (e.g., FIREFOX, SAFARI Plug-in, and/or the like APIs), and/or the like. Web browsers and like information access tools may be integrated into PDAs, cellular telephones, and/or other mobile devices.

A web browser may communicate to and/or with other components in a component collection, including itself, and/or facilities of the like. Most frequently, the web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 336 may have additional features or functionality, and additional interfaces to facilitate communications between the basic configuration and any desired devices and interfaces. For example, a bus/interface controller is used to facilitate communications between the basic configuration and data storage devices via a storage interface bus 302. The data storage devices may be one or more removable storage devices, one or more non-removable storage devices, or a combination thereof. Examples of the one or more removable storage devices and the one or more non-removable storage devices include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus facilitates communication from various interface devices (e.g., one or more output devices 338, one or more peripheral interfaces 346, and one or more communication devices 354) to the basic configuration via the bus/interface controller 310. Some of the one or more output devices 338 include a graphics processing unit 340 and an audio processing unit 344, which are configured to communicate to various external devices, such as a display or speakers, via one or more A/V ports 342.

The one or more peripheral interfaces 346 may include a serial interface controller 350 or a parallel interface controller 352, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 348.

Further, the one or more communication devices 354 may include a network controller 356, which is arranged to facilitate communication with one or more other computing devices 360 over a network 210 communication link via one or more communication ports 358. The one or more other computing devices 360 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 332, the one or more removable storage devices 304, and the one or more non-removable storage devices 306 are examples of the computer-readable storage media. The computer-readable storage media is a tangible device that can retain and store instructions (e.g., program code) for use by an instruction execution device (e.g., the computing device 336). Any such, computer storage media is part of the computing device 336.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 334 of a general purpose computer, special purpose computer, or other programmable data processing apparatus (e.g., the computing device 336) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 336), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages (e.g. Python). The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A device for monitoring a vehicle environment, the device comprising:
a housing, which is approximately rectangular having six faces;
a first image capturing device;
a second image capturing device;
a third image capturing device;
a fourth image capturing device, each of the image capturing devices being substantially at a ninety degree angle from each other, which results in three hundred and sixty degree coverage, wherein each is positioned on one face of the housing excluding a top face and a bottom face;
a digital image sensor having a singular surface that receives light from each of the image capturing devices;
a processor configured to preform digital signal processing tasks on output from the digital image sensor to produce a set of digital media files, which include image files and video files, wherein image files are stored in a standardized image format viewable via a conventional media player, wherein video files are stored in a standardized video format viewable via a conventional media player; and
a data store that stores the digital media files,
wherein the device permits a user to independently control and determine how output from each of the image capturing devices is processed, wherein said independent control permits a video file to be created that includes video from a first subset of one to three of the image capturing devices while concurrently permitting creation of a set of at least one image files from a user selected second subset of one to three of the image capturing devices, wherein none of the image capturing devices of the first subset are in the second subset.

2. The device of claim 1, wherein each of the image capture devices directs captured optical imagery on different, substantially non-overlapping regions of the digital image sensor.

3. The device of claim 2, wherein the processor comprises at least four cores, wherein specific cores are dedicated to digital signal processing of specific ones of the image capturing devices.

4. The device of claim 1, wherein each of the image capturing devices comprises a lens that optically channels light to ultimately strike a surface of the digital image sensor.

5. The device of claim 1, further comprising:
a wireless transceiver configured for live streaming of the images captured by the any of a user selected subset of the image capturing devices thereby allowing the vehicle and its occupants to be viewed in real time.

6. The device of claim 1, further comprising:
a mounting apparatus, wherein the mounting apparatus permits free rotation of the device while being used.

7. The device of claim 1, further comprising:
a speed detector component, which is at least one of a radar detector and a LIDAR detector,
wherein the device is configured to responsive to the speed detection component sensing occurrence of a speed detection activity targeting the vehicle, the image capturing devices are automatically activated to begin continuously capturing images in the three hundred and sixty degree coverage, wherein said captured images are stored in the data store within at least one of the media files.

8. A device for monitoring a vehicle environment of a vehicle, the device comprising:
a housing, which is approximately rectangular having six faces;
a first image capturing device;
a second image capturing device;
a third image capturing device;
a fourth image capturing device, each of the image capturing devices being substantially at a ninety degree angle from each other, which results in three hundred and sixty degree coverage, wherein each is positioned on one face of the housing excluding a top face and a bottom face;
a digital image sensor having a singular surface that receives light from each of the image capturing devices;
a processor configured to preform digital signal processing tasks on output from the digital image sensor to produce a set of digital media files;
a data store that stores the digital media files; and
a speed detector component, which is at least one of a radar detector and a LIDAR detector,
wherein the device is configured to responsive to the speed detection component sensing occurrence of a speed detection activity targeting the vehicle, the image capturing devices are automatically activated to begin continuously capturing images in the three hundred and sixty degree coverage, wherein said captured images are stored in the data store within at least one of the media files.

9. The device of claim 8, further comprising:
a GPS component, which is configured to calculate a speed of the vehicle via GPS computations,
wherein the speed is recorded in a time synchronized fashion with the captured images.

10. The device of claim 8, further comprising:
a GPS component linked to a navigation display, said navigation display indicating a location in space, wherein an indication of the location is recorded into the captured images in a time synchronized fashion with the captured images.

11. The device of claim 8, wherein the set of digital media files resulting from the digital signal processing includes include image files and video files, wherein image files are stored in a standardized image format viewable via a conventional media player, wherein video files are stored in a standardized video format viewable via a conventional media player,
wherein the device permits a user to independently control and determine how output from each of the image capturing devices is processed, wherein said independent control permits a video file to be created that includes video from a first subset of one to three of the image capturing devices while concurrently permitting creation of a set of at least one image files from a user selected second subset of one to three of the image capturing devices, wherein none of the image capturing devices of the first subset are in the second subset.

12. The device of claim 11, wherein each of the image capture devices directs captured optical imagery on different, substantially non-overlapping regions of the digital image sensor.

13. The device of claim 11, wherein each of the image capturing devices comprises a lens that optically channels light to ultimately strike a surface of the digital image sensor.

14. The device of claim 11, further comprising:
a mounting apparatus, wherein the mounting apparatus permits free rotation of the device while being used.

15. A device for monitoring a vehicle environment of a vehicle, the device comprising:
a housing, which is approximately rectangular having six faces;
a first image capturing device;
a second image capturing device;
a third image capturing device;
a fourth image capturing device, each of the image capturing devices being substantially at a ninety degree angle from each other, which results in three hundred and sixty degree coverage, wherein each is positioned on one face of the housing excluding a top face and a bottom face;
a digital image sensor having a singular surface that receives light from each of the image capturing devices;
a processor configured to preform digital signal processing tasks on output from the digital image sensor to produce a set of digital media files;
a data store that stores the digital media files; and
a mounting apparatus, wherein the mounting apparatus permits free rotation of the device while being used.

16. The device of claim 15, wherein the set of digital media files resulting from the digital signal processing includes include image files and video files, wherein image files are stored in a standardized image format viewable via a conventional media player, wherein video files are stored in a standardized video format viewable via a conventional media player,
wherein the device permits a user to independently control and determine how output from each of the image capturing devices is processed, wherein said independent control permits a video file to be created that includes video from a first subset of one to three of the image capturing devices while concurrently permitting creation of a set of at least one image files from a user selected second subset of one to three of the image capturing devices, wherein none of the image capturing devices of the first subset are in the second subset.

17. The device of claim 16, wherein each of the image capture devices directs captured optical imagery on different, substantially non-overlapping regions of the digital image sensor.

18. The device of claim 15, further comprising:
a speed detector component, which is at least one of a radar detector and a LIDAR detector,
wherein the device is configured to responsive to the speed detection component sensing occurrence of a speed detection activity targeting the vehicle, the image capturing devices are automatically activated to begin continuously capturing images in the three hundred and sixty degree coverage, wherein said captured images are stored in the data store within at least one of the media files.

19. The device of claim 15, further comprising:
a wireless transceiver configured for live streaming of the images captured by the any of a user selected subset of the image capturing devices thereby allowing the vehicle and its occupants to be viewed in real time.

20. The device of claim 15 wherein the mounting apparatus is configured to couple the device to a dashboard of a vehicle or a window of the vehicle.
